(19) United States
(12) Patent Application Publication
(10) Pub. No.: US 2007/0266816 A1
(43) Pub. Date: Nov. 22, 2007

(54) Adjustable pedal device

(76) Inventors: Ralf Jakobi, Florsheim (DE); Horst Kramer, Ginsheim-Gustavsburg (DE); Michael Haber, Frankfurt (DE); Jurgen Schonlau, Walluf (DE); Holger Kranlich, Karben (DE); Thomas Sellinger, Offenbach (DE)

Correspondence Address: RATNERPRESTIA, P O BOX 980, VALLEY FORGE, PA, 19482-0980, US

(21) Appl. No.: 11/820,958

(22) Filed: Jun. 21, 2007

Related U.S. Application Data
(62) Division of application No. 10/528,728, filed on Mar. 22, 2005.

(30) Foreign Application Priority Data
Sep. 27, 2002 (DE) 102 45 524.4
Sep. 27, 2002 (DE) 102 45 523.6
Nov. 28, 2002 (DE) 102 55 786.1

(51) Int. Cl. G05G 1/14

(52) U.S. Cl. 74/512

(57) ABSTRACT

The present invention relates to an adjustable pedal device including at least two pedals whose initial position is variable. A pedal device is disclosed wherein a control member is rotatably articulated at the pedal lever for the brake, while the lever is rotatable about a third axis. It is disadvantageous in the prior art construction that a second pedal, particularly an accelerator pedal, cannot be simultaneously adjusted according to said principle because the forces acting upon the individual pedals are not effective in the same direction. The invention relates to a pedal device which has a simple design and in which the initial position of the mentioned two pedals can be adjusted in a substantially uniform manner, the two pedals being mounted in a twistable mounting support while being rotated about axes that are offset one relative to the other.

### RELATED APPLICATIONS

This application is a Divisional Application of U.S. patent application Ser. No. 10/528,728 filed Mar. 22, 2005.

### TECHNICAL FIELD

The present invention relates to a pedal device for motor vehicles enabling to control various vehicle components. It is desired in many cases to easily adapt a vehicle to different drivers. For example, there are various adjustments for mirrors which can be recorded by a counter so as to be reproducible. As soon as a driver adjusts the individually predefined count of a counter, the single mirrors are moved into the respectively predetermined position. In view of the different body length of individual drivers, proposals have been made to adapt the position of the individual pedals to the respective vehicle operator.

### BACKGROUND OF THE INVENTION

Thus, EP-OS 918 273 discloses a pedal assembly wherein the pedals suspended on a mounting support can be swiveled along with the mounting support. The brake pedal described therein suffers from the disadvantage that the brake booster is actuated in a tractive motion. An additional deflection is necessary when conventional brake boosters are used.

DE-OS 29 41 345 discloses an adjustable pedal assembly. Two pedal levers arranged on a mounting support are jointly swiveled with the mounting support. It is simultaneously possible to displace the mounting support along with the two pedals on a straight line with respect to the support's attachment. The resulting relations of kinematics are rather unclear so that there are objections against using this construction in large series production. Furthermore, a control member, e.g. brake actuator, for controlling the brake is attached to the mounting support itself and swivelable jointly with the pedals.

DE-OS 100 28 591 discloses a pedal device wherein a control member is rotatably articulated to the pedal lever and rotatable about a third axis. A third axis is in alignment with the axis of rotation of the mounting support. Although the position of the third axis will change only insignificantly when the pedal lever is adjusted due to swiveling of the mounting support, the pedal device suffers from the shortcoming that it is inappropriate to adjust an accelerator pedal simultaneously with the brake pedal because the kinematical conditions at an accelerator pedal are inconsistent with the kinematical conditions at a brake pedal. Among others, this is due to the fact that the brake pedal has to apply a compressive force, while the accelerator pedal must exert a tensile force on the carburetor cable.

U.S. Pat. No. 6,324,939 discloses a pedal device wherein the brake pedal and the accelerator pedal can be adjusted together. To this end, two movable mounting supports are provided which bring about a joint adjustment of accelerator pedal and brake pedal. The first mounting support is adjustable in an axial direction. The adjustment of the first mounting support causes swiveling of not only the brake pedal itself but also the second mounting support at which the accelerator pedal is rotatably suspended. The construction described in the mentioned U.S. patent is complicated. In addition, both the second mounting support and the brake pedal have elongated holes in the area suspended at the first mounting support so that a sliding guide for the last mentioned components is obtained by these provisions, while entailing high expenditure.

### BRIEF SUMMARY OF THE INVENTION

In view of the above, an object of the invention is to disclose a pedal device, which exhibits a simple design and allows a substantially uniform, synchronous adjustment of an accelerator pedal and a brake pedal.

This object is achieved in that a second pedal lever is mounted in the mounting support, preferably at an extension of the mounting support, so as to be rotatable about a fourth axis. Hence, the invention principally involves disclosing a pedal device managing with one single adjustable mounting support. While in U.S. Pat. No. 6,324,939 a second mounting support is suspended in the first mounting support by way of an elongated hole and is additionally swiveled about an axis at the holder, in the invention at issue, both the brake pedal and the accelerator pedal are rotatably mounted at the single movable mounting support without elongated holes in a surprisingly simple fashion.

When the control member is arranged in an only axially displaceable manner, the position of the point of application at the brake pedal is also displaced in the pedal device of the invention when the mounting support is swiveled, and that is to say the more the farther the point of application is remote from the first axis E and the closer it is to the second axis B. Further, the displacement is the greater, the greater the pivoting angle is. As the brake pedal is rotatably suspended, the position of the point of application changes also when the brake pedal is applied, with the control member being only axially displaceable.

To permit greater displacements of the point of application and, thus, greater adjustments of the pedals, a favorable improvement of the invention is advisable, according to which a control member acts on the device to be adjusted by way of a ball-and-socket joint, said device being preferably configured as a brake booster or master cylinder.

In a furthermore preferred variant, a pressure force is exerted on a control member by way of the brake pedal, while a tensile force is exerted on a carburetor cable by way of the accelerator pedal. In this arrangement, the two pedal plates are adjustable in their initial position by a considerable amount of roughly equal magnitude, and a comparatively simple construction is achieved. One embodiment permits both an actuation of a throttle for the gas supply and an actuation of a braking system.

A larger degree of freedom in the range of adjustability is rendered possible when a separate guide rod and a swiveling lever are provided between the first pedal lever for the brake actuation and a piston rod at a brake booster or a master brake cylinder, with said guide rod being articulated at the pedal lever and the piston rod. Said degree of freedom is not reached in the state of the art due to the arrangement of the brake booster and master brake cylinder formed fast with the vehicle.

Advantageously, the pedal device is attached because the holder is fastened to a so-called splashboard on the vehicle. Alternatively, a separate transverse bar can be provided, on which the pedal device is arranged.

Another degree of freedom in the way of the arrangement of the pedal device is reached by providing the extension with a projection that encompasses the steering column in such a fashion that the steering column can be arranged optionally on the right or on the left of the pedal device.

Principally, the invention allows a manual adjustment of the pedal device. In a favorable improvement of the invention, the invention also provides a motor drive acting on the mounting support and swiveling it by a predefined amount. In this arrangement, the motor drive preferably includes an electric motor provided with a gear and being rotatably anchored at the mounting support.

It is also rendered possible by a motive adjustment provision to store defined adjustments associated with a defined driver in a memory. This way, it is possible for several drivers of the same vehicle to poll their own adjustment values, with the reproduction of the individual adjustments of the pedal device occurring automatically.

Theoretical reflections verified by tests lead to the following favorable variant. A device where the first axis E lies on the point of intersection of the mid-verticals of two distances, with the first distance being defined by the displacement of the second axis B during the adjustment and the second distance being defined by the displacement of the fourth axis D during the adjustment, allows arranging the distances of the individual axes in such a fashion that when the mounting support is swiveled both the pedal plate of the brake pedal and the pedal plate of the accelerator pedal are displaced by the same amount within the passenger compartment. This achieves a synchronization of the adjusting movements, and it is ensured that the pedal plates adopt the same distance relative to each other in each adjusting position.

In a further development of the invention, a clutch pedal can be pivoted in the mounting support in addition to the brake and accelerator pedals. It is advisable for a simultaneous adjustment of the clutch pedal that for its location in the mounting support an axis of rotation is provided which is radially offset relative to the axis of rotation (B) of the brake pedal. A preferably hydraulic generating cylinder for the clutch will then make catch with its ends both at the mounting support and the pedal lever of the clutch. The same applies to a spring, which can reset the pedal lever of the clutch into a non-actuated rest position.

Another favorable embodiment of the invention relates to a pedal device with so-called E-gas (electronic gas pedal), and a driver's request is determined by way of a sensor, e.g. a rotary potentiometer. If the accelerator pedal or the sensor is coupled directly to the lever of the bracket, an analog adjustment of the accelerator pedal in relation to the brake pedal is no longer possible. The actuation plate of the accelerator pedal would automatically move about the pivot of the mounting support.

An adjustment of the E-gas pedal in the same way as the brake pedal is rendered possible according to a favorable embodiment of the invention. As this occurs, the E-gas pedal is retained at one end by way of a suitable coupling to the splashboard or the fixed part of the pedal mounting support.

Further relevant embodiments of the invention can be taken from sub claims.

### BRIEF DESCRIPTION OF THE DRAWINGS

FIG. 1 is a symbolic illustration of a front view of an embodiment with individual swivel axes that are offset in parallel relative to each other, with the steering column being arranged on the left of the pedal assembly.

FIG. 2 is a symbolic illustration of another embodiment with parallel offset swivel axes, with the steering column being arranged on the right of the pedal assembly.

FIG. 3 is a symbolic illustration of a side view of the embodiments according to FIG. 1 and FIG. 2, wherein the pedal lever for the brake pedal is illustrated in two different initial positions.

FIG. 4 is a symbolic illustration of a variant of the invention with E-gas including individual swivel axes that are offset in parallel relative to one another.

FIG. 5 is a symbolic illustration of a side view of the embodiment according to FIG. 4, wherein the pedal lever for the accelerator pedal is illustrated in two different initial positions.

FIG. 6 is a diagrammatic sketch of a variant wherein a separate guide rod is provided between a first pedal lever and a piston rod for the actuation of a brake booster, said guide rod allowing a larger degree of freedom in the range of adjustability of the pedal device.

### DETAILED DESCRIPTION OF THE PREFERRED EMBODIMENTS

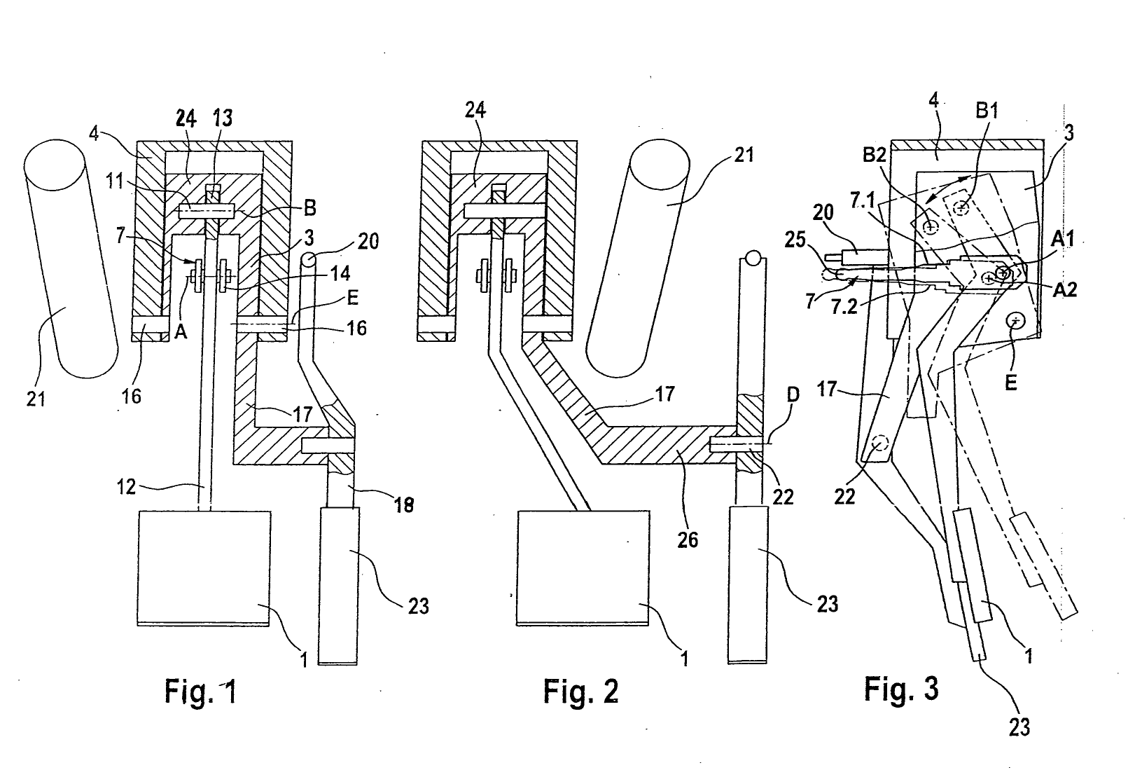

In FIG. 1 a holder 4 is indicated which can be composed of several sheets or designed as a molded part made of aluminum or plastics. Holder 4 can be attached with its bottom portion interconnecting the two holder legs to a splashboard or a transverse beam of a non-illustrated vehicle. A mounting support 3 is pivoted in the holder 4. The rotation can occur by way of a motor acting on the mounting support 3. Details in this respect can be taken from DE 100 28 591 A1 in particular, the respective disclosure thereof being expressly included in the present application.

As indicated in FIG. 1, the holder 4 can consist of two parallel sheets, which project vertically from the splashboard.

As becomes apparent from FIGS. 1 and 2, the mounting support 3 substantially comprises two rigidly interconnected parallel sheets, which in turn are aligned in parallel to the two sheets of the holder 4. The mounting support 3 is pivoted in the holder 4, with the mounting support 3 being swivelable about the first axis E with respect to the holder 4.

As this occurs, the rotation takes place by way of two aligning bearing pins 16. Thus, when a motor acts on the top end 24 of the mounting support 3, the mounting support 3 is turned about a swivel axis E, which forms the center line for the bearing pins 16. In order to obtain a higher degree of stability when the projection 26 (as shown in FIG. 2) is used for the bearing D of the accelerator level 18, said projection can also be pivoted by another bearing pin (16) on the first axis E by way of a bracket (not shown in FIG. 2) connected to the projection.

As becomes apparent from FIGS. 1 to 3, the top end 13 of a pedal lever 12 is pivoted by means of a transverse pin 11 in the mounting support 3. Rotation takes place about a second axis B, as can be seen in FIG. 3. As can be seen in FIGS. 1 and 3, the pedal lever 12 is additionally supported on the free end of an actuating rod 7 of a non-illustrated brake booster at the level of the third axis A. Thus, in the initial condition, the angular position of the pedal lever 12 is predetermined by means of the position of the two axes of rotation B and A in relation to each other.

If, for example, the mounting support 3 in FIG. 3 and, hence, the axis B in FIG. 3 is swiveled counterclockwise to the left, the pedal plate 1 will also swivel counterclockwise about the axis A to the left and, thus, in the direction of the driver's feet. Because the swivel axis B lies very far at the top and the pedal lever 12 is relatively long, the pedal plate 1 will cover already quite a long distance at a small angle.

It can be seen in FIG. 3 how a rotation of the mounting support 3 about the first axis E causes displacement of the position of the second axis B from B1 to B2, but in particular also of the position of the third axis A from A1 to A2. Figure 3 exhibits that the control member 7 adopts a different angular position, depending on the rotary position of the mounting support 3. More specifically, if the control member is displaceable only in its longitudinal direction, swiveling of the mounting support and, hence, the pedal lever and actuating of the pedal lever by means of foot pressure will take influence on the position of the point of application A of the actuating rod 7 at the pedal lever 12 (which remains on the axis A1). To avoid damage to the control member 7, it is necessary to provide a curved elongated hole covering the points A1 and A2 when the control member is not swivellable. Another solution is discernible from FIG. 3 in an improvement of the invention. In this case, the control member 7 is swivellable about a spherical head 25 in the brake booster not shown. A1 and A2 are then desired to lie on a circle about the spherical head 25, if possible.

In comparison with DE 100 28 591 A1, the subject matter of the present application is still distinguished by a protrusion 17 that projects from the mounting support 3 in a downward direction. An accelerator pedal 18 is pivoted at this protrusion 17 by means of a rotary pin 22. Comparable with the abutment of pedal lever 12 on point A, the top end of the accelerator lever 18 is secured by means of a Bowden cable 20 so that when a pressure force is exerted on the pedal plate 23, the accelerator pedal is turned about the rotary pin 22 and, thus, the center line D of the rotary pin 22, and a throttle valve (not shown) is hereby opened by way of the carburetor cable 20. It can be seen that when the mounting support 3 is swiveled as shown in FIG. 3, the top end of the accelerator lever 18 is fixed by means of the Bowden cable 20 so that the bearing pin 22 along with the protrusion is tilted in a forward direction, with the accelerator lever 18 rotating about the rotary pin 22 on account of the captivation of the top end of the accelerator lever 18 caused by the Bowden cable. As has been described hereinabove, the individual axes can be arranged in such a fashion that upon swiveling of the mounting support 3, the pedal plate 1 and the pedal plate 23 are swiveled about the same amounts in a forward direction.

The invention is not limited to the detailed configuration of the individual circuit components illustrated in the Figures. Thus, e.g. the mounting support 3 and also the holder 4 can be respectively illustrated by one single sheet.

In the embodiment of FIG. 3, there is no need to employ a fork 14 with a retaining pin at the open end of the actuating rod 7 when it is ensured that the actuating rod 7 with its open end makes e.g. catch at the outside contour of the pedal lever at the level of the axis of rotation A. The mentioned point of application A of the actuating rod 7 at the pedal lever 12 shall not be considered as a geometrical single point.

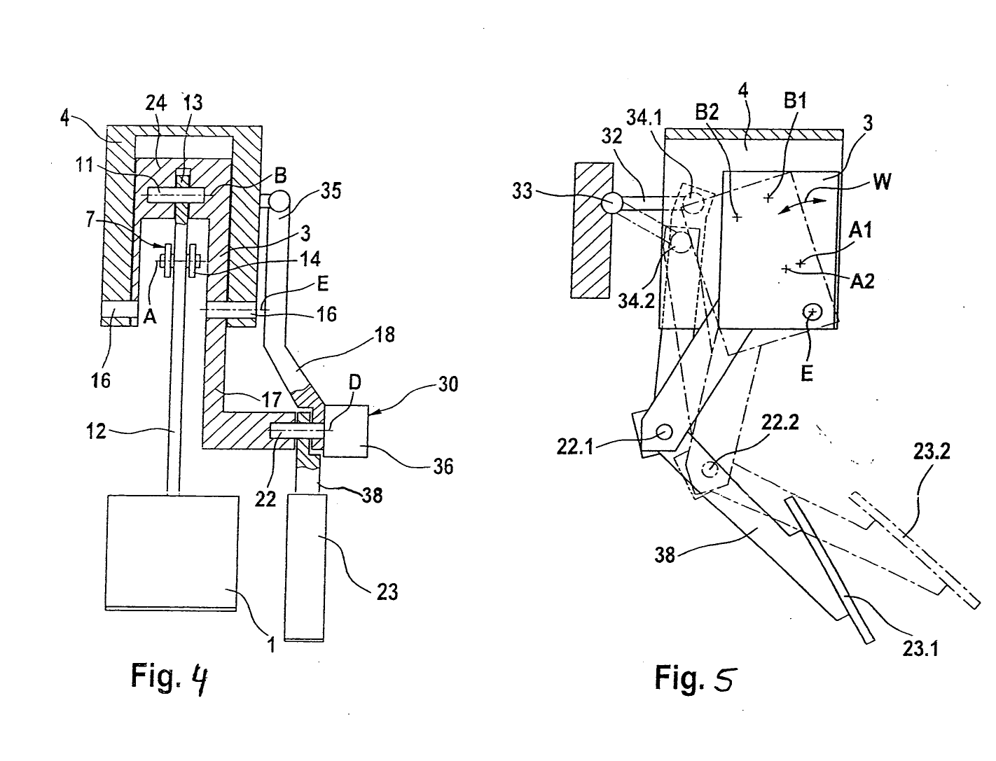

FIG. 4 refers to a variant of the invention with E-gas and is to a wide extent concurrent with the variant according to FIGS. 1 to 3 so that reference is made to the related passages of the description in order to avoid unnecessary repetitions, and only differences will be explained more closely hereinbelow.

In the variant with a transducer for an E-gas generator 30 according to FIGS. 4 and 5, a carburetor cable like in FIGS. 1 to 3 is not available, which could retain the accelerator pedal 18 upon adjustment of the mounting support 3 at its top end. However, in order to be able to swivel the accelerator lever 18 about the axis D when the mounting support 3 is swiveled about the axis E, the Bowden cable is replaced by a captivation in the form of a swiveling lever 32. Said swiveling lever 32 can be connected, e.g. by way of joints 33, 34, to the top end of the accelerator pedal 18 or the holder 4 or any other point fixed with respect to the vehicle. Another possibility involves replacing the swiveling lever 32 by a rope or cable.

When the mounting support 3 is tilted by a certain angle W (see FIG. 5) about the axis E, the rotary pin 22.1 will move to adopt the position 22.2. Accordingly, the joint 34.1 moves to the position 34.2 and the pedal plate 23.1 moves to the position 23.2. It is thus ensured that the adjustment of the pedal plate 23 is also possible in the absence of a carburetor control cable acting on the top end 35 of the accelerator pedal 18.

The accelerator pedal 18 is integral and, thus, stiff in the solution according to FIGS. 1 to 3. The pedal lever 18 is defined by way of the swiveling lever 32 and the bearing pin 22 in two points in the variant according to FIGS. 4 to 5. E-gas actuation and a simultaneous adjustment provision are rendered possible as follows. The pedal lever 18 for the gas is provided with an attachment 38 that is rotatable by means of the bearing pin 22 in relation to the pedal lever 18. In this arrangement, the housing 36 of the generator 30 includes the pedal lever 18, and a movable control member of the generator acts on the attachment 38. A reverse constellation is also feasible. When the attachment 38 is moved in relation to the accelerator pedal 18, the position of the control member relative to the housing 36 will also change so that a rotational speed of the engine desired by the driver can be output by the generator by way of a corresponding output signal. Further, the generator has a spring resetting the attachment 38 into its initial position when the force applied to the pedal plate 23 declines, said initial position being defined by a stop, and additionally ensures the desired pedal feeling upon actuation of the pedal plate.

In the variant according to FIGS. 4 to 5, the pedal lever 18 is divided at the suspension in point D so that the divided pedal parts are subjected to different tilting maneuvers. The upper part of the accelerator pedal 18 is automatically moved about pivots E in the pedal mounting support (holder 4) by means of an articulated swiveling lever 32. As this occurs, a relative movement of the lever 38 is allowed in point D, 22 during the swiveling action. Sensing can be executed between the top and bottom parts of the accelerator pedal (18, 38). This is advantageous compared to sensing at the accelerator pedal mounting support because it is not required to initialize a new zero point (reference point) after each adjusting movement of the pedal device.

Summarizing, all variants have the following advantages. A driver-related adjustment of the actuating pedal for tall and small drivers is rendered possible. Apart from improving the ergonomic conditions (ease of access to the instruments and switches) and the comfort, above all, safety-related conditions are improved. A too short distance between the driver and the steering wheel and, hence, the airbag is avoided. Typical injuries caused by the airbag may thus be minimized. The adjustment of the accelerator pedal analogously to the brake pedal (same adjustment travel, same adjusting direction) is permitted.

Summarizing, the invention that permits a simultaneous adjustment of brake pedal and accelerator pedal can be described briefly as follows.

Adjustable pedal modules allow a driver-related adjustment of the actuating pedals for tall and small drivers. Apart from improving the ergonomic conditions (ease of access to the instruments and switches) and the comfort, above all, safety-related conditions are improved. A too short distance between the driver and the steering wheel and, hence, the airbag is avoided. Typical injuries caused by the airbag may thus be minimized.

It is favorable in the development of an adjustable pedal module (APM=adjustable pedal module) to illustrate the same adjustment travel for all pedals. Due to the different kinematics of the accelerator pedal with respect to the brake pedal, however, this is not possible with the means described in DE 100 28 591 A1.

In U.S. Pat. No. 6,324,939 B1 of Cicotte, a mechanism for the simultaneous adjustment of accelerator pedal and brake pedal is described. The adjusting mechanism of the brake pedal used in this patent is realized by way of a slide rail. Both the pivot of the brake pedal and a lever necessary for the adjustment of the accelerator pedal are displaced in elongated holes. This mechanism involves the risk of jamming and is complicated.

Compared thereto, the application at topic describes a solution permitting an adjustment of the accelerator pedal similarly to the brake pedal. In general, the adjustment of the mounting support is effected in a rotatory fashion. There is no need, however, for a separate lever according to U.S. Pat. No. 6,324,939 B1.

In principle, the improvement of the invention includes a bracket (mounting support 3) pivoted in a holder. Apart from the function of the pedal adjustment by a motor as described in DE-OS 100 28 591, an additional extension (protrusion 17) is provided at the mounting support 3, carrying the accelerator pedal 18. The accelerator pedal is mounted on a separate fourth axis D. Upon application of the pedal 18, rotation about this point D takes place, and the carburetor cable 20 is actuated by means of the top end of the pedal 18. Depending on the position of the steering column 21, various embodiments of the mounting support including integrated lever 17 are possible (see FIGS. 1 and 2). The embodiment of this shaped lever must be conformed to the free length of the carburetor cable actuated by the accelerator pedal. Both pedals are adjusted by way of the same axis of rotation E. The different kinematics of the pedals is illustrated in FIG. 3.

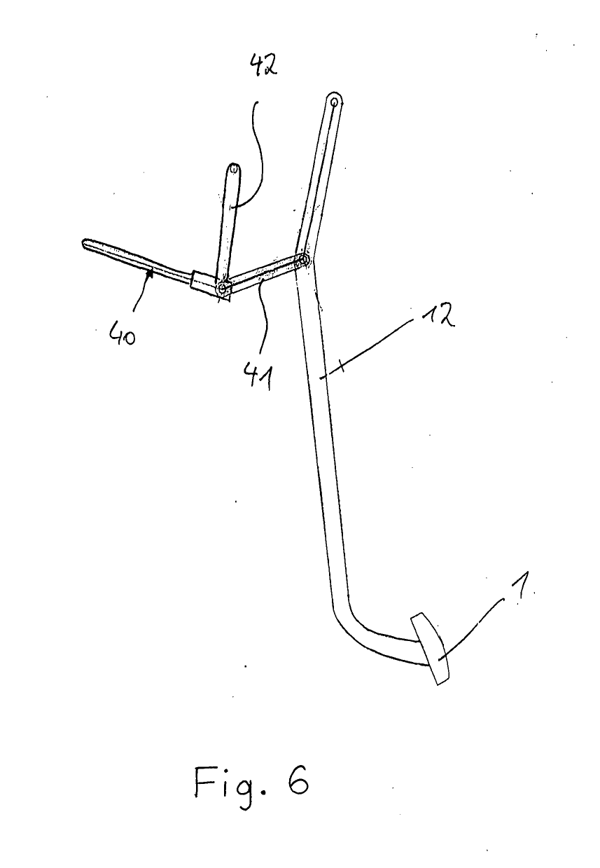

FIG. 6 relates to an improvement, which can be employed in connection with all embodiments. A larger degree of freedom in the range of adjustability is rendered possible when a separate guide rod 41 and a swiveling lever 42 are provided between the first pedal lever 12 for the brake actuation and a piston rod 40 at a brake booster or a master brake cylinder, with said guide rod being articulated at the pedal lever 12 and the piston rod 40. Said degree of freedom is not reached in the state of the art due to the arrangement of the brake booster and master brake cylinder formed fast with the vehicle.

The invention enables the adjustment of the accelerator pedal analogously to the brake pedal (same adjustment travel, same adjusting direction) without having to use an additional separate lever according to U.S. Pat. No. 6,324,939 B1. A pure rotation—without sliding guide—allows a precise guiding and a rattle-free safe function with little effort.

What is claimed:

1. An adjustable pedal device for a motor vehicle, with a holder being fixed to a vehicle body, with a mounting support in the holder, the mounting support having a top section, a bottom section and a midsection between the top and bottom sections, the mounting support being pivoted about a first axis at the midsection, and the top and bottom sections being free to rotate about the first axis, with at least one first pedal lever pivotally mounted in the mounting support about a second axis, and with the first pedal lever acting by way of a point of application upon a control member by rotating about the second axis so that the point of application displaces by a displacement travel,
wherein a second pedal lever is pivotally mounted on the bottom section of the mounting support, so as to be rotatable about a fourth axis.

2. The pedal device as claimed in claim 1,
wherein the control member with its first end is mounted in the pedal lever so as to be rotatable about a third axis, and wherein a second end of the control member is tiltably mounted on a brake booster or a master cylinder.

3. The pedal device as claimed in claim 1,
wherein the second axis and the fourth axis are offset in relation to each other, and wherein the fourth axis is arranged below the first axis, and wherein the first axis is arranged below the second axis.

4. The pedal device as claimed in claim 3,
wherein the first pedal lever is used for the actuation of a brake booster or a master cylinder of a brake system, and wherein the second pedal lever serves for the engine speed control, with the lower free ends of the pedal levers being furnished with pedal plates.

5. The pedal device as claimed in claim 1,
wherein the holder is fastened to a splashboard of the vehicle.

6. The pedal device as claimed in claim 1,
wherein the protrusion is provided with a projection that encompasses the steering column in such a fashion that the steering column can be arranged optionally on the right or on the left of the pedal device.

7. The pedal device as claimed in claim 1,
wherein the mounting support is swiveled by means of an electric drive, said drive being configured as an electric motor equipped with a gear and being rotatably anchored at the holder.

8. The pedal device as claimed in claim 1,
wherein the first axis lies on the point of intersection of the mid-verticals of two distances, with the first distance being defined by the displacement of the second axis during the adjustment and the second distance being defined by the displacement of the fourth axis during the adjustment.

9. The pedal device as claimed in claim 1,
wherein a pedal lever of a clutch device is additionally pivoted in the mounting support.

10. The pedal device as claimed in claim 4,
wherein a second end of the second pedal lever acts on a carburetor control for the engine speed control.

11. The pedal device as claimed in claim 1, with the first pedal lever being used for the actuation of the booster or master cylinder of a braking system, and the second pedal lever being used for the engine speed control, and with the lower free ends of the pedal lever being furnished with pedal plates,
wherein a free, second end of the second pedal lever is captivated relative to the holder, and wherein the second pedal lever is furnished with a lower pedal attachment that is rotatably articulated at the second pedal lever for engine speed control, with the point of support being arranged in the area between the fourth axis and the pedal plate of the accelerator pedal, and with a transducer being active for sensing a swiveling movement between the lower pedal attachment and the second pedal lever.

12. The pedal device as claimed in claim 11,
wherein the transducer is designed as an E-gas generator whose housing is stationarily arranged at the second pedal lever on the one hand, and with a movable control member of the E-gas generator acting on the lower pedal attachment, or vice-versa.

13. The pedal device as claimed in claim 11,
wherein an axis of rotation of the pedal attachment is in alignment with the fourth axis.

14. The pedal device as claimed in claim 11,
wherein the second end of the second pedal lever in relation to the holder is captivated in such a fashion that it is swivellable by a predetermined maximum angle in relation to a defined fastening point on the holder.

15. The pedal device as claimed in claim 14,
wherein the second end is captivated in relation to the holder by means of a swiveling lever or a rope.

16. The pedal device as claimed in claim 11,
wherein a stop is provided which limits a rotation of the pedal attachment in relation to the second pedal lever.

17. The pedal device as claimed in claim 16,
wherein a spring is provided which biases the pedal attachment in relation to the second pedal lever towards the stop.

18. The pedal device as claimed in claim 17,
wherein the spring is integrated into the housing of the E-gas generator.
